(19) United States
(12) Patent Application Publication
(10) Pub. No.: US 2004/0067412 A1
(43) Pub. Date: Apr. 8, 2004

(54) Portable electronic device, power supplying device and power supplying method

(75) Inventors: Hiroshi Shimizu, Yokohama (JP); Kiyoshi Nishikawa, Tokyo (JP); Shinichi Obata, Fujisawa (JP); Masahiko Saito, Mito (JP); Atsuchi Ogino, Kodaira (JP); Jun Maeoka, Kawasaki (JP); Nobuaki Kohinata, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/449,227

(22) Filed: May 29, 2003

(30) Foreign Application Priority Data
Oct. 2, 2002 (JP) 2002-289378

(51) Int. Cl. H01M 10/48; H01M 10/46; H04B 1/38; H02J 7/00

(52) U.S. Cl. 429/92; 320/101; 455/573

(57) ABSTRACT

A portable electronic device receives notification from a base station showing that the amount of energy or fuel remaining in a battery is low. The portable electronic device then has a display showing the remaining amount of energy or fuel in the battery is low in accordance with the notification. Location information is received by a location information receiving section, and is transmitted to the base station. The portable electronic device receives fuel supplying device information showing the location of a device able to supply fuel or give a charge of electricity to the battery from the base station. A supplying device provides the fuel or gives the charge of electricity in accordance with information transmitted from the portable electronic device, and transmits information showing the compensation owed to the base station.

### BACKGROUND OF THE INVENTION

The present invention relates to a portable electronic device, a power supplying device and a power supplying method.

Lithium ion batteries are often used in portable telephones, and charged by a charger when the remaining battery energy is low. However, there are few cases in which a user carries the charger. Therefore, when the remaining battery energy runs is low and the user is not where the charger is kept, the problem arises that the battery cannot be charged and the portable telephone cannot be used. JP-A-2000-101756 discloses a public telephone set having a charger and located on a public street to as a solution for this problem. Further, use of a fuel battery as the power source of a portable electronic device has been considered in lieu of a storage battery such as the lithium ion battery, etc. A fuel battery mounted to a portable device such as a notebook computer, for example, has been disclosed in JP-A 213359.

In the invention described in JP-A-9-213359, hydrogen stored in a hydrogen occlusion cartridge is used as fuel, and the hydrogen occlusion cartridge is exchanged when all the stored hydrogen is consumed. More precisely, the hydrogen occlusion cartridge is exchanged for the first time when the fuel runs out. Therefore, when this prior art is applied to a portable telephone set and an unexpected call arrives just before the fuel runs out, there is a concern that the telephone conversation and information communicated will be cut off by depleted fuel.

In the invention described in JP-A-2000-101756, the user must to drop a coin or insert a card into the public telephone set to pay for charging the battery. Accordingly, when a user does not have change or a card, the battery cannot be charged at the necessary time. Further, when the user notices that the remaining battery energy for the portable telephone is low and running out, a charger corresponding to the make and model of the portable telephone carried by the user is not always near the user's location. Therefore, the user must search for a public telephone set having a charger corresponding to the model of his or her portable telephone.

### BRIEF SUMMARY OF THE INVENTION

This invention provides a device and a method that can easily perform the required charging operation or that can easily replenish the fuel for a portable electronic device. To that end, a portable electronic device receives position information at a position information receiving section and transmits the position information and information about the portable electronic device model to a base station. In turn, the base station sends the portable electronic device recharging/refueling device information (subsequently referred to as “supplying device”) showing the position of a supplying device able to supply fuel or to electrically charge the battery. The portable electronic device also transmits information to the supplying device regarding the portable electronic device model and the required amount of fuel or charging. The supplying device provides fuel or electrical charging in accordance with the information transmitted from the portable electronic device, and transmits fee-for-service information to the base station.

### BRIEF DESCRIPTION OF THE DRAWINGS

FIG. 1 shows embodiments of the system of the present invention.

FIG. 2 is a front view showing the external appearance of a portable telephone set.

FIG. 3 is a rear view showing the external appearance of the portable telephone set.

FIG. 4 is a block diagram of the portable telephone set.

FIG. 5 is a perspective view showing a fuel supplying device.

FIG. 6 is a block diagram showing the structure of the fuel supplying device.

FIG. 7 is a perspective view showing the portable telephone set mounted to the fuel supplying device.

FIG. 8 is a perspective view showing the fuel cartridge.

FIG. 9 shows a screen display of the fuel supplying device.

FIG. 10 shows the transactions of the portable telephone set, the fuel supplying device and a base station according to one embodiment.

FIG. 11 shows the transactions of the portable telephone set, the fuel supplying device and the base station in an automatic fuel-supplying mode according to another embodiment.

FIG. 12 shows the transactions of the portable telephone set, the fuel supplying device and the base station in a fuel cartridge-supplying mode according to this embodiment.

FIG. 13 shows the display of the portable telephone set; with FIG. 13A showing a menu screen and FIG. 13B showing a waiting-receiving screen.

FIG. 14 shows the display of the portable telephone set; with FIG. 14A showing a menu screen and FIG. 14B showing a waiting-receiving screen.

FIG. 15 shows the display of the portable telephone set; with FIG. 15A showing an automatic supply starting screen, FIG. 15B showing an estimate screen, FIG. 15C showing a screen during automatic supply, and FIG. 15D showing an automatic supply terminating screen.

FIG. 16 shows the display of the portable telephone set according to another embodiment, where FIG. 16A shows the initial screen of a cartridge purchase, FIG. 16B shows a correction screen for the purchase quantity in a cartridge purchase, and FIG. 16C shows a purchase approval screen.

FIG. 17 is a flow chart of the processes shown above.

FIG. 18 is an additional flow chart of the processes shown above.

FIG. 19 is a perspective view showing an example of a fuel supplying device.

### DETAILED DESCRIPTION OF THE INVENTION

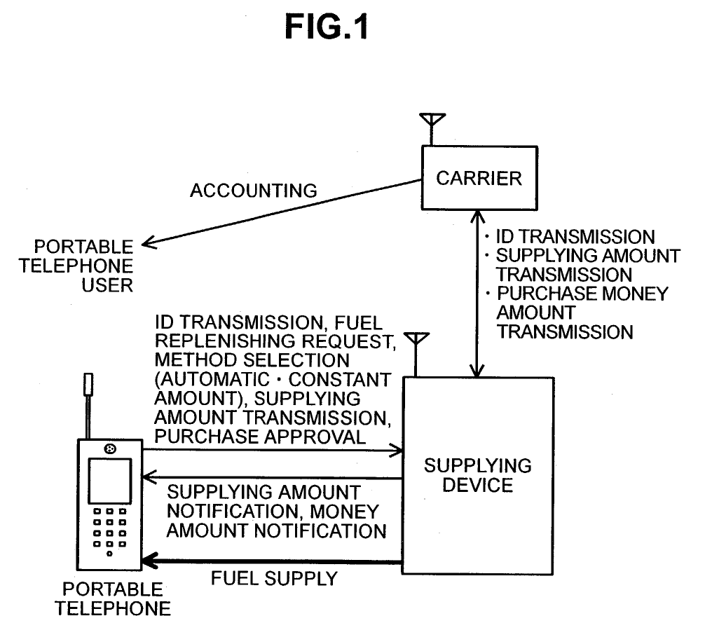

The embodiments are explained with reference to the drawings. FIG. 1 shows a system for supplying fuel to a portable telephone set 400 using a fuel battery. This system includes a portable telephone set 400, a base station 900 of a carrier (a telecommunications service provider for wireless telephones), and a fuel supplying device 600 for supplying fuel to portable telephone 400. Each configuration and a fuel supplying method will be explained sequentially.

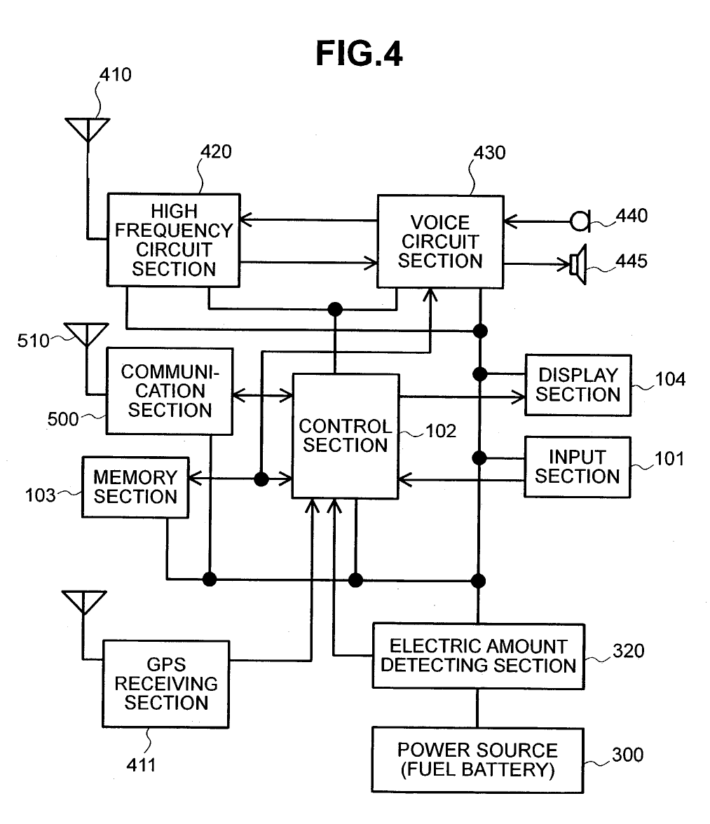

FIG. 4 is a block diagram showing the configuration of portable telephone 400 in this embodiment. A high frequency circuit section 420 is connected to an antenna 410, and functions as a high-frequency section for transmitting and receiving signals with respect to the base station. A voice circuit section 430 is connected to high-frequency circuit section 420, and functions as a low-frequency section for converting the output of high-frequency circuit section 420 to an audio signal and converting the audio signal to a high-frequency signal. A control section 102 connected to high-frequency circuit section 420 and voice circuit section 430 controls each section using a control program stored in memory section 103, and control data. An input section 101 is used to assign a transmitting destination or to set a function, and inputs information as data communication with the Internet or electronic mail, etc.

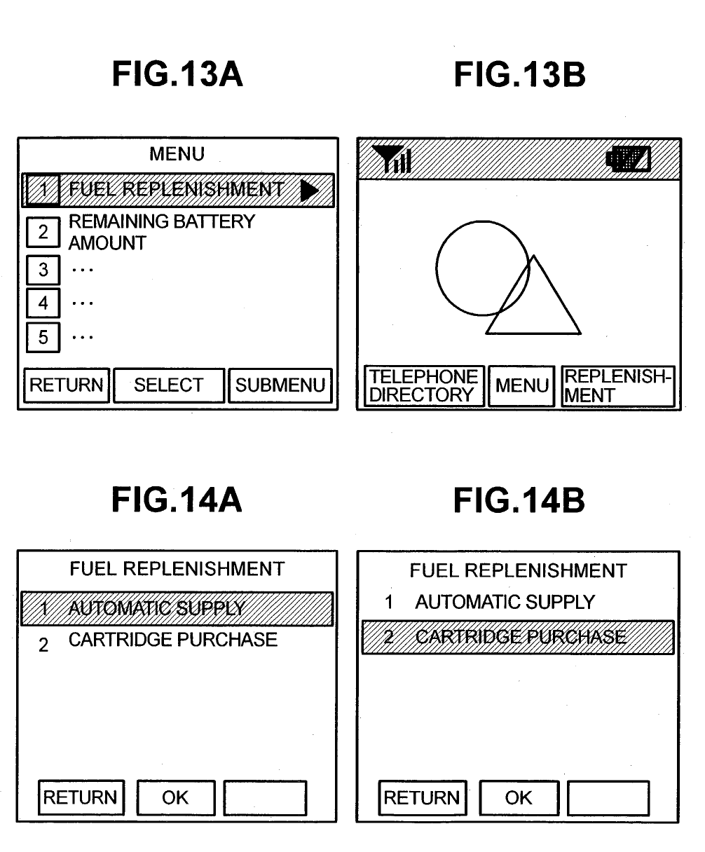

For example, a display section 104 is a color liquid crystal display unit, is controlled by control section 102, and performs a display operation. In a waiting-receiving state, display section 104 displays a radio wave state, the remaining amount of battery fuel or energy, a date and an hour. Display section 104 displays a screen for setting various kinds of functions when functions are being set, and displays the telephone number of a telephone conversation partner, a name, a nickname, a portrait, the image of a face, etc. when a signal is being transmitted or is arriving. When data is communicated to the Internet, electronic mail, etc., display section 104 displays transmitted and received information. Display section 104 also displays image information and character information as an input screen or a receiving screen of data communication. This image information is a static image or a dynamic image. Further, display section 104 displays the screens shown in FIGS. 13 to 15 when fuel is being replenished.

A communication section 500 is connected to control section 102, and information is wirelessly communicated between communication section 500 and fuel supplying device 600 at a frequency different from that used in signal transmission and reception, with respect to base station 900, through an antenna 510. A fuel battery 300 is arranged on the back side of input section 101 and supplies power to each section through an electricity amount detecting section 320. In this embodiment, control section 102 has a function for calculating the amount of electricity supplied by fuel battery 300, and a signal relating to this amount is transmitted through high-frequency circuit section 420 or communication section 500.

Portable telephone 400 in this embodiment also has a GPS receiving section 411, and can receive location information showing the location of t portable telephone 400 from a GPS satellite. This location information is transmitted to base station 900 through antenna 410 in accordance with the instructions of a user.

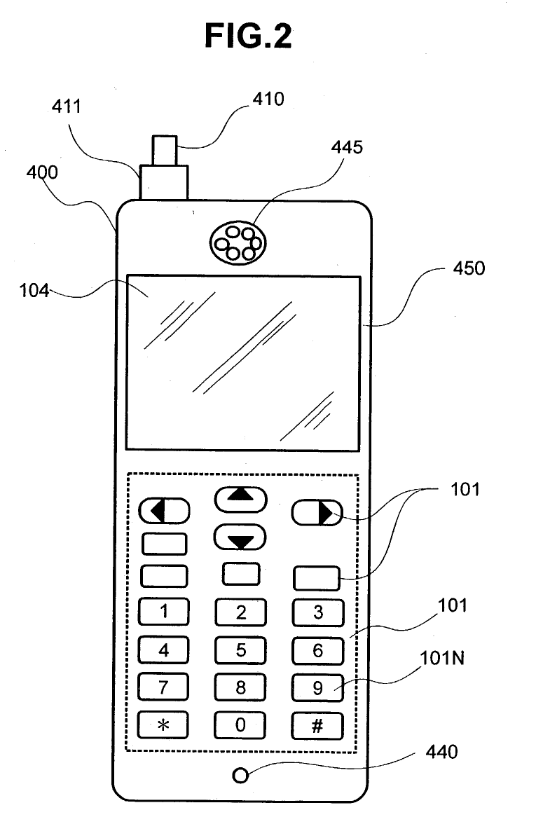

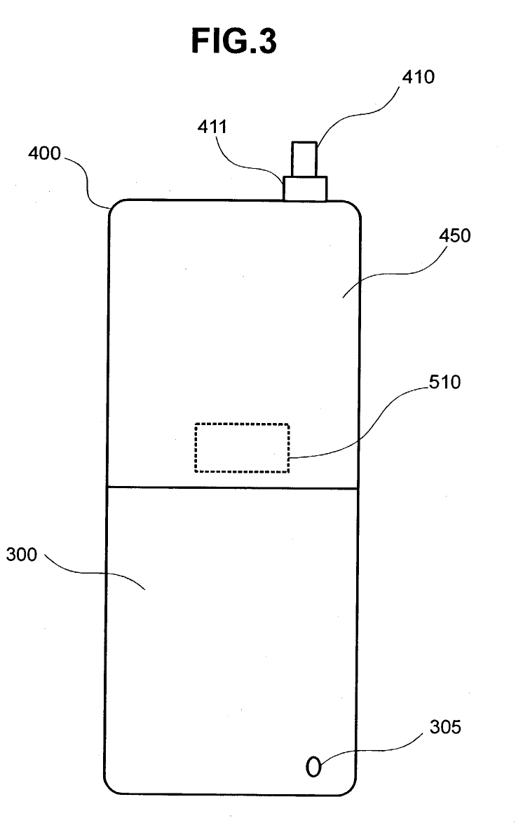

For convenience in this explanation, when the component-arrangement side of the portable telephone's case 450 is defined as the front side of the case, a receiver 445 and a transmitter 440 are respectively arranged in both end portions in the longitudinal direction on the front side of the portable telephone; display section 104 is arranged on the side near receiver 445 and input section 101 is arranged on the side near transmitter 440, as shown in FIG. 2. Further, as shown in FIG. 3, fuel battery 300, a fuel supplying port 305 for supplying fuel to the fuel battery, and antenna 510 for communicating with fuel supplying device 600 are on the back side of portable telephone 400.

As shown in FIG. 2 input section 101 has both numerical value keys 101N and function keys 101F. The numeric keys include ten numeral keys from “0” to “9”, an asterisk (*) key and a pound (#) key, and the function keys include up, down, left and right keys. (Up, down, left and right refer to positions as seen from the front side when transmitter 445 is set to the upper side, as shown in FIG. 2.) Function keys are used to move a cursor or to scroll a screen. Input section 101 also has a soft key for setting various kinds of functions.

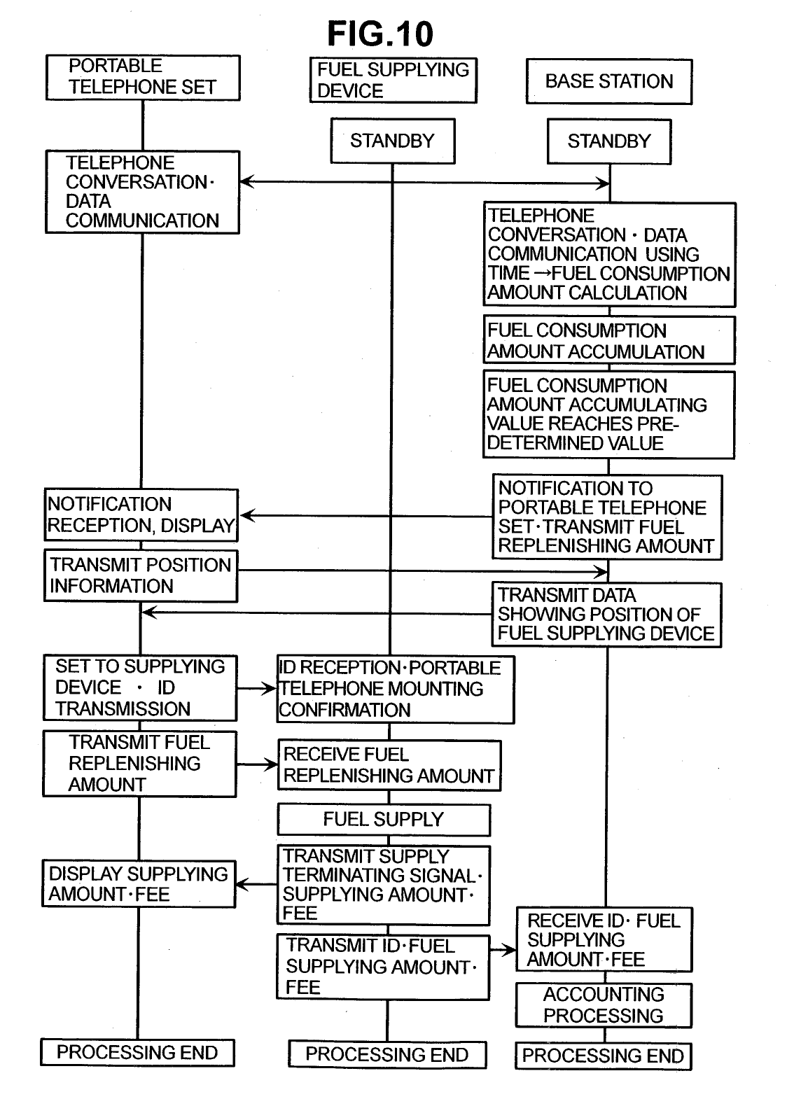

A method for supplying fuel to portable telephone 400 is explained with reference to FIG. 10. Base station 900 receives a signal relating to an amount of electricity from portable telephone 400, and calculates the consumption of fuel on the basis of this signal. Here, for example, the signal relating to the amount of electricity is a signal showing a telephone conversation time, the data amount of mail transmission and reception or a using time of the data communication of the Internet, etc. Power consumption increases as telephone conversation time lengthens as email transmission and reception are increased, and as the usage time of data communication is lengthened. (Input time lengthens and power consumption increases as the data amount increases, particularly in mail transmission.) Base station 900 collects the telephone conversation time, the amount of data used for mail, and the usage time for data communication by communicating with portable telephone 400, and uses the telephone conversation time, etc. as the signal relating to the amount of electricity. Base station 900 estimates the amount of electricity used on the basis of this signal, and calculates the fuel consumption amount from this electricity amount.

When portable telephone 400 communicates wit base station 900, the portable telephone transmits ID information including information for- distinguishing the telephone number and model of portable telephone- 400. Every portable telephone is ascertained by its ID information. Base station 900 stores data showing the fuel consumption amount to a fuel consumption amount database. When the accumulated amount of the stored fuel consumed reaches a predetermined value (a threshold value), base station 900 presumes the remaining fuel- in portable telephone 400 is a small amount and that a fuel supply is required (a fuel supply mode). Base station 900 notifies portable telephone 400 that the time to refuel is near. This notification is by both an email message and a voice message, and says that refueling is necessary and shows the amount of the fuel to be supplied. For example, the threshold value is set to 90% of the capacity of the fuel tank (the fuel-holding portion of the fuel battery) of portable telephone 400. Thus, a user can easily learn of the need to refuel from the notification from base station 900 with the arrival of the electronic mail and voice messages, e.g., even when the user stores portable telephone 400 in a bag and forgets about refueling.

Further, in this embodiment, base station 900 calculates the remaining amount of fuel using the elapsed telephone conversation time, etc. of portable telephone 400. Therefore, it is possible to send notification that the refueling is required even when no data showing the remaining amount of fuel have been transmitted from portable telephone 400.

Portable telephone 400 has an electricity amount detector 320 for calculating the amount of electricity supplied by fuel battery 300, and transmits the amount detected by detector 320 to base station 900 at predetermined intervals. Base station 900 may send notification when the accumulated value of the detected amount of electricity exceeds a threshold value. When portable telephone 400 receives notification from base station 900 or the amount of electricity detected by detector 320 exceeds the threshold value, display section 104 displays the remaining, amount of fuel (as shown in FIG. 13B), showing that the amount is small (the rightward upper display of the battery in FIG. 13B) and also displays a message such as “The fuel is nearly gone. Refueling is required.” The time left for telephone conversation and the time left for receiving data may be calculated by base station 900 or control section 102 of portable telephone 400, based on the remaining amount of fuel in the battery, and the message about the need to refuel, or instead of the message, the time left for telephone conversation, etc. may be displayed in display section 104. The need to refuel can be easily understood by showing this need according to a cut-off time.

The user may input a preferred minimum time left for telephone conversation and for receiving data, and a refueling message may be also displayed when the remaining amount of fuel in the battery is running low at this user-specified time. For example, the degree of emergency related to refueling is different when the user is located on or near a street where finding a refueling supplier is easy and when the user is located in an area such as the suburbs, etc. where the number of refueling suppliers is small. Therefore, user convenience can be improved by setting a notification time in keeping with the user's preferences.

Portable telephone 400 transmits the location information received by GPS receiving section 411 to base station 900 in accordance with the instructions of the user. Base station 900 has a fuel supplying device database for storing the location data of the fuel supplying device, map data corresponding to the location data, and data showing the makes and models of the portable telephones each fuel supplying device is adapted for. When location information showing the where portable telephone 400 is received, the map data showing the locations of the fuel supplying devices nearest portable telephone 400 are read from the fuel supplying device database and are transmitted to portable telephone 400 on the basis of locale and the make and model of the portable telephone.

There is a situation in which no user can know where the fuel can be replenished even when the user recognizes that it is immediately necessary to refuel portable telephone 400. There is also a situation in which no fuel replenishing device has been adapted for the make or model of portable telephone carried by the user, even when a fuel replenishing device is found. In this embodiment, since map data of the fuel supplying device adapted for portable telephone 400 are transmitted from base station 900, the user can easily replenish the fuel in the portable telephone set. Further, information showing fuel unit cost and benefit information may be transmitted together with the map information. Thus, when there are multiple fuel supplying devices near the user, the user can determine where the fuel is preferably supplied. Therefore, user convenience is improved.

Further, in this embodiment, location information is transmitted to base station 900 only when user instructions to do so are received from the base station adapted for the user's portable telephone. Therefore, the user's privacy can be protected; the communication connection between portable telephone 400 and base station 900 is reduced; and power consumption by the portable telephone can be controlled. The location information may also be also set to be transmitted, at the user's discretion at each notification interval. In this case, since base station 900 can recognize the location of portable telephone 400 in advance, the base station can transmit the map data for the fuel supplying devices together with the notification.

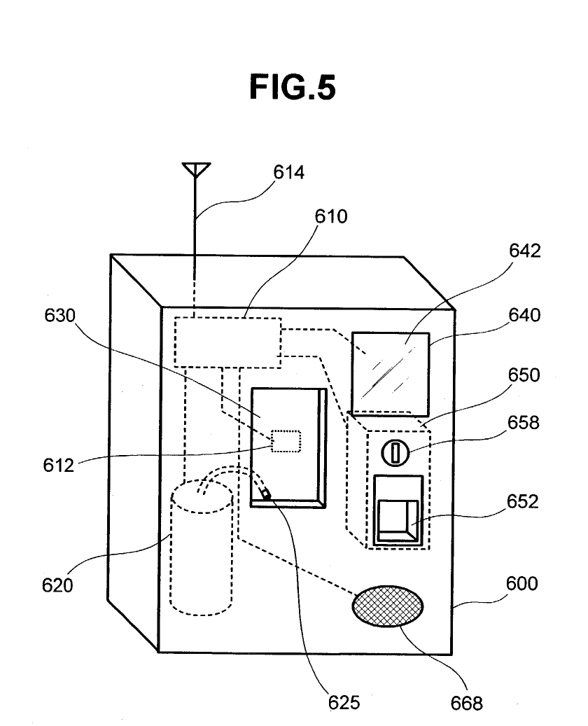

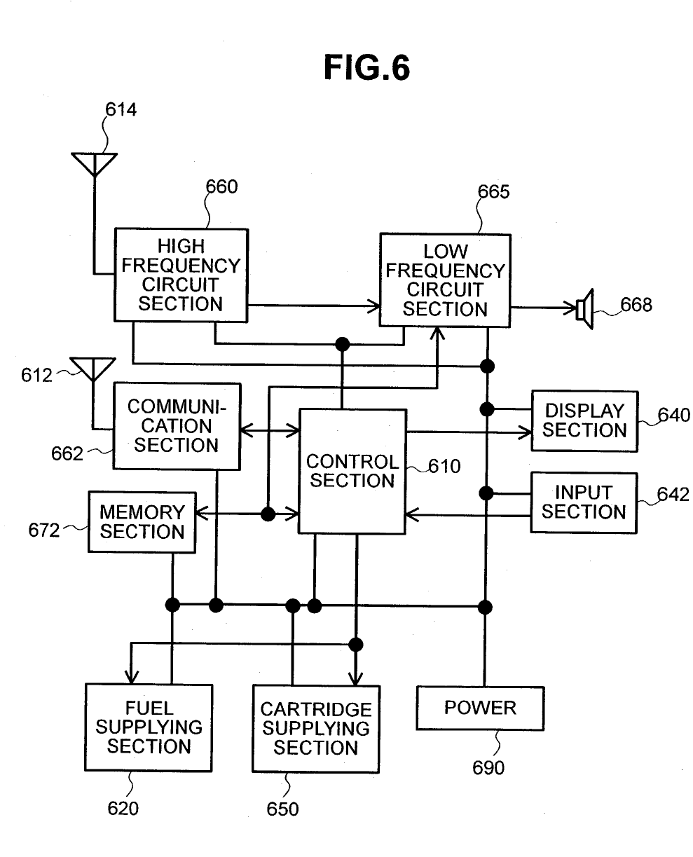

Fuel supplying device 600 used in this embodiment is explained with reference to FIGS. 5 to 7. FIG. 6 is a block diagram showing the configuration of fuel supplying device 600. A memory section 672 stores a program and data required in the control of section 610. Further, memory section 672 stores information inputted from portable telephone 400, information sent from base station 900, and information relating to transactions in accordance with necessity. A high-frequency circuit section 660 is connected to an antenna 614, and communicates with base station 900 through the control of control section 610. Control section 610 controls the operations of high-frequency circuit section 660, a low-frequency circuit section 665, a fuel supplying section 620 having a fuel tank and a pump, a cartridge supplying section 650, a communication section 662 for transmitting and receiving signals through an antenna 612 between communication section 662 and portable telephone 400, a display section 640, an input section 642, a memory section 672 and a voice guidance device 668. Control section 610 also calculates a fuel replenishing amount and a fuel fee. A power source 690 supplies power to input section 642, display section 640, low-frequency circuit section 665, high-frequency circuit section 660, control section 610, communication section 662, memory section 672, cartridge supplying section 650 and fuel supplying section 620.

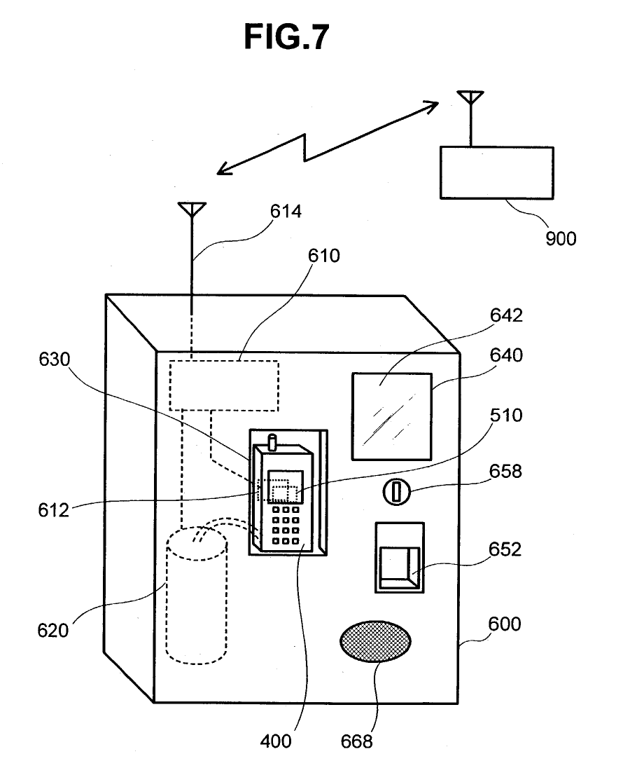

FIGS. 5 and 7 are perspective views showing fuel supplying device 600. A portable telephone mounting portion 630 for mounting portable telephone 400 is arranged on the face of fuel supplying device 600. In this portable telephone mounting portion 630, a signal receiving section 612 is arranged in a position corresponding to antenna 510 of portable telephone 400, and a tap 625 of fuel supplying section 620 is arranged in a position corresponding to a fuel supplying port 305 of portable telephone 400. As shown in FIG. 7, when portable telephone 400 is mounted to portable telephone mounting portion 630, tap 625 is inserted into fuel supplying port 305 to prevent fuel leakage.

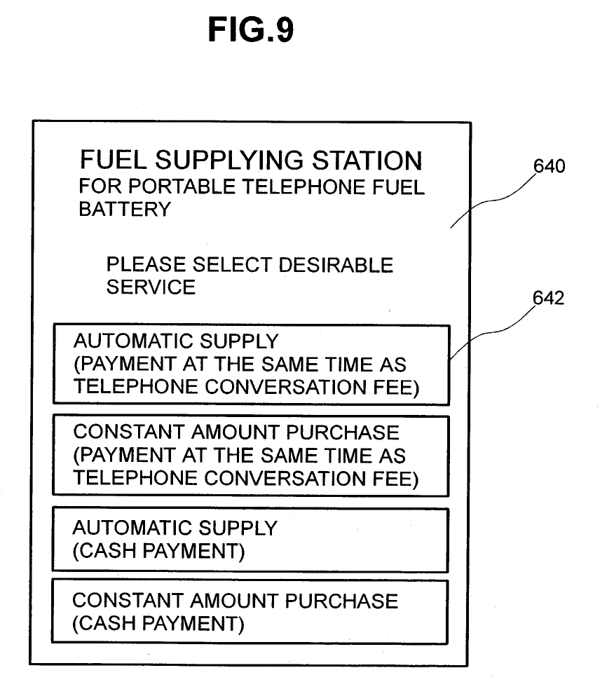

Display device 640 is composed of a liquid crystal display unit, and has input section 642 of a touch panel on its surface. Display device 640 is constructed such that the screen of display device 640 can be seen from the exterior of fuel supplying device 600 and an input operation can be performed. For example, a guidance screen is displayed, as shown in FIG. 9, on the screen of display device 640, and the user can select a fuel supplying method by making contact with touch panel portion 642. Voice guidance device 668 is controlled by control section 610 and performs the voice guidance required to control the user's operation of fuel supplying device 600.

When portable telephone 400 is mounted to fuel supplying device 600 as shown in FIG. 7, portable telephone 400 transmits its ID information and specifies the amount of the fuel to be supplied. This information is transmitted from base station 900 through communication section 500 and antenna 510 as shown in FIG. 10. Fuel supplying device 600 receives the information through antenna 612 and communication section 662. In the embodiment shown in FIG. 10, the fuel replenishing amount is transmitted after the ID information is first transmitted. However, the ID and the fuel replenishing amount may be simultaneously transmitted.

Control section 610 generates a signal for controlling the operation of fuel supplying section 620 on the basis of this information, and refuels portable telephone 400 through tap 625. When refueling is finished, fuel supplying device 600 transmits the amount of fuel supplied and the cost to portable telephone 400. Portable telephone 400 displays this amount of fuel supplied and the cost in display section 104. Thus, the user is made aware of the cost r refueling. In this embodiment, the user is notified of the amount of money owed after the fuel is supplied. However, the user may be notified of the cost before the fuel is supplied, and the refueling may be also be started after the user confirms the cost. In accordance with this arrangement, it is possible to prevent expenses unintended by the user.

Fuel supplying device 600 transmits the amount of fuel supplied and the amount of money charged to base station 900 together with the ID information of portable telephone 400. Base station 900 performs account processing by adding the amount of money received from fuel supplying device 600 to a telephone fee, using the portable telephone's ID information. Thus, the user of portable telephone 400 can obtain refueling even if the user has only a small amount of money.

Fuel supplying device 600 has a coin port 658, and the user can select cash payment on the selecting screen shown in FIG. 9. Fuel supplying device 600 also has a receipt-issuing function, and may print the fuel supplying amount, the amount of money, a shop name (an enterprise company name), a date, an hour, etc. as a receipt and may then issue the receipt under the control of control section 610.

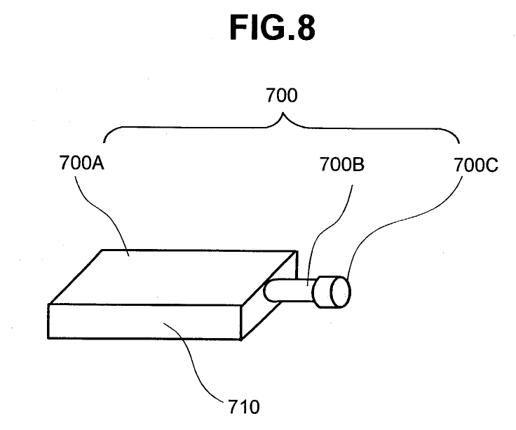

In the above embodiment, the fuel is directly replenished in fuel battery 300 of portable telephone 400. However, fuel supplying device 600 can also provide a fuel cartridge (hereinafter called a cartridge) 700 fuel sealed within a container as shown in FIG. 8. The cartridge is issued from a cartridge removal port 652. Cartridge 700 is composed of a body portion 700A for storing the fuel, a neck portion 700B having a shape that can be inserted into fuel supplying port 305 of portable telephone 400, and a cap (cover) 700C detachably mounted to neck portion 700B and preventing the fuel from flowing out. Cartridge 700 is sold in a state in which cap 700C is closed and the fuel cannot flow out. At refueling, the user detaches cap 700C and replenishes the fuel. Cartridge 700 is formed from synthetic resin having a flexible property so as to easily release the fuel when the user presses cartridge 700. The cartridge 700 is formed such that the height of a side surface 710 is approximately equal to the outside diameter of neck portion 700B. Cartridge 700 is most preferably formed in a thin shape in which doesn't take up much space in storage until it is sold, and no cartridge 700 is bulky even when the user puts the cartridge into a pocket.

In accordance with this embodiment, the base station can maintain the fuel consumption for every user. Accordingly, at refueling, the cartridge may be gratuitously supplied as a premium to a user using up fuel equal to or greater than a predetermined amount for a certain period (i.e., the user frequently uses services (telephone conversation, mail, the Internet, etc. of the carriers). Thus, using the services of the carriers can be promoted.

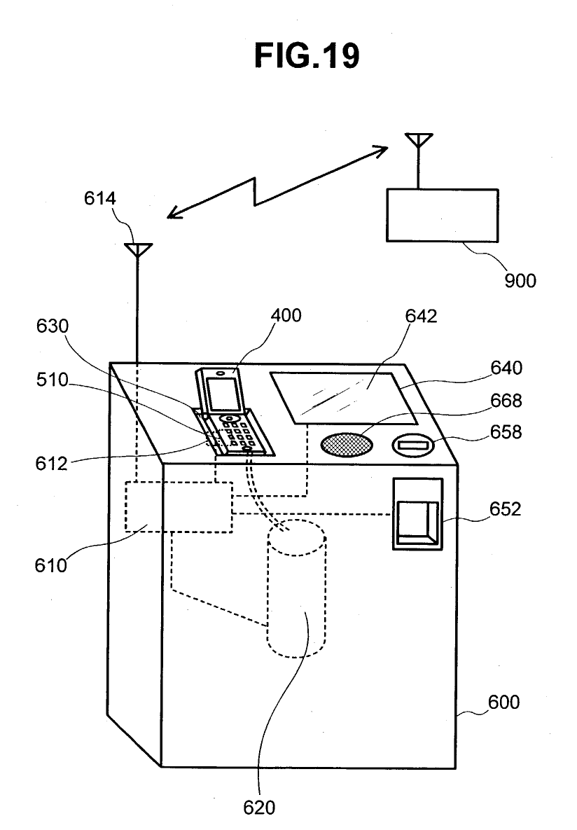

A modified example of fuel supplying device 600 is now explained with reference to FIG. 19. In this modified example, fuel supplying device 600 is constructed such that a folding type portable telephone 400 can be mounted to portable telephone mounting portion 630 in an open state (a state able to perform an input operation). A display section 640, an input section 642 and a coin port 658 are arranged on the upper surface of fuel supplying device 600 so as to be easily operated by the user. The upper surface of fuel supplying device 600 is arranged to have a predetermined angle with respect to a horizontal surface. This angle is preferably set to range approximately from 0 to 45 degrees, and is desirably set to range from 10 degrees to 40 degrees in view of operability of the user, the ease of seeing of the display section and the stability offered when a portable telephone is mounted on the upper surface. A portable telephone of an unfolding bar type may be also mounted to fuel supplying device 600 of this modified example.

In the explanation of the above embodiment, portable telephone 400 has fuel battery 300 as an exemplary power source. However, the present invention may be also applied to a case in which the portable telephone set having a storage battery is charged. In this case, base station 900 transmits notification showing that charging is required for the portable telephone, and information showing the location of a charger and a fee. Account processing is performed by adding compensation for the charging to the telephone fee.

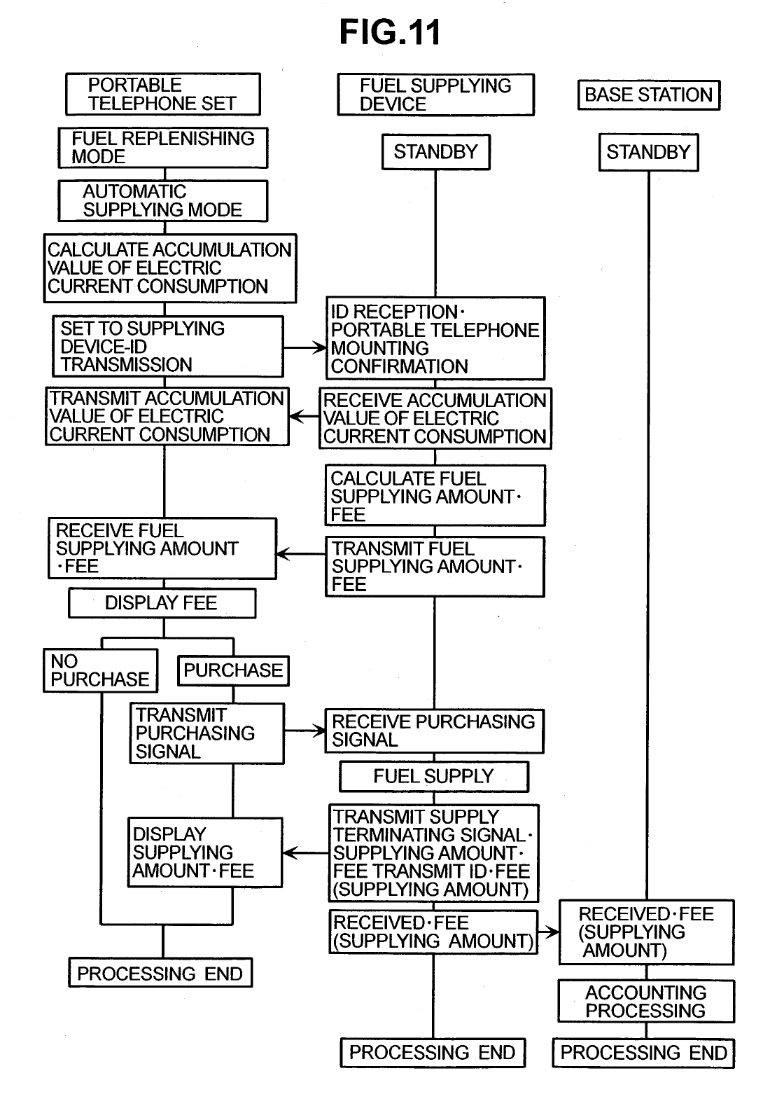

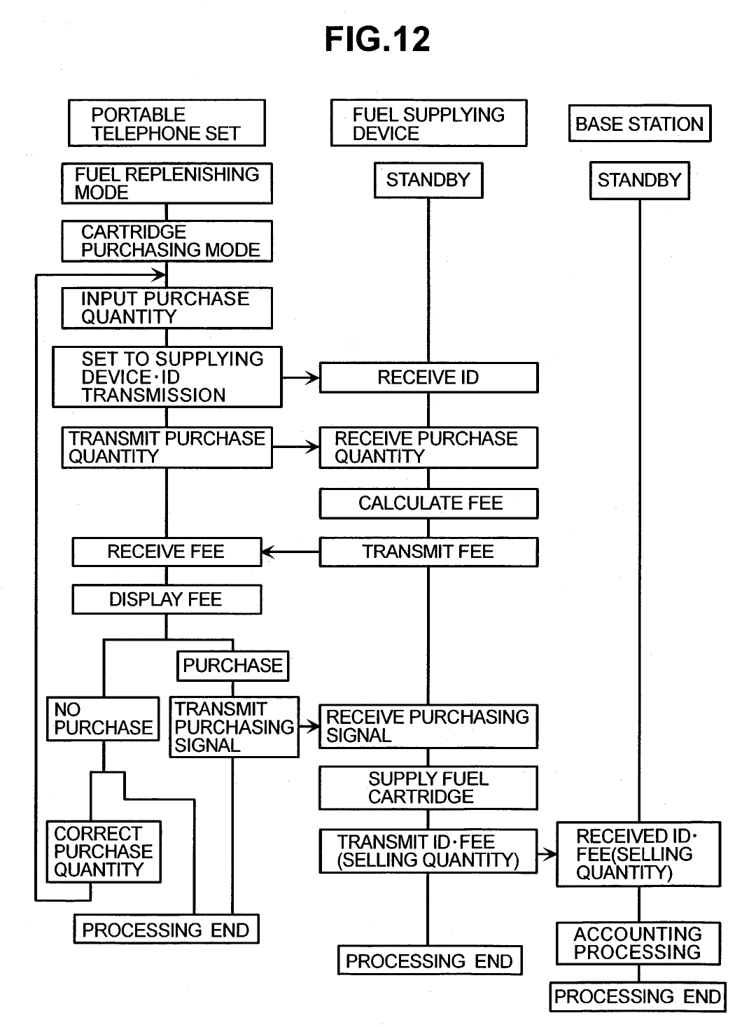

A second embodiment is explained next. The configuration of the hardware of portable telephone 400, a fuel/power supplying device 600 and a base station 900 in this embodiment is the same as in the first embodiment, and its explanation is therefore omitted. In this embodiment, as shown in FIG. 11, portable telephone 400 transmits to fuel supplying device 610 an amount of electricity detected by electricity amount detector 320 The required power supply amount calculated in control section 610 of the fuel/power supplying device 600, and the fuel/power is supplied to portable telephone 400. As shown in FIG. 12, a cartridge is purchased by using portable telephone 400.

A control section 102 of the portable telephone calculates the remaining amount of power in the battery on the basis of the amount of electricity detected by electricity amount detecting section 320, and displays the amount of power remaining in the battery in a battery figure in the upper right of the screen in display section 104 as shown in FIG. 13B. FIG. 13B shows a waiting-receiving screen. When the user of the portable telephone operates the key corresponding to a “menu” for input section 101 in this state, control section 102 displays the menu screen shown in FIG. 13A in display section 104. When the amount of power remaining in the battery is small, control section 102 preferentially displays menus such as “fuel replenishment” or “remaining battery life”, etc. relating to power.

When the user operates the key corresponding to a submenu of input section 101 on the screen of FIG. 13A, the screen of display section 104 becomes the selection screen for the fuel replenishing method shown in FIG. 14A. When the user wants power to be automatically supplied, the user operates the key corresponding to “OK” in input section 101 or “1” of a numeric value key. When the user wants to purchase a cartridge, the user operates the cursor key of input section 101, moves a block cursor downward, and sets the screen display of FIG. 14B, Then the user operates the key corresponding to “OK” of input section 101. Otherwise, the user operates “2” of the numeric value key in FIG. 14A. The user then selects a cartridge purchasing mode.

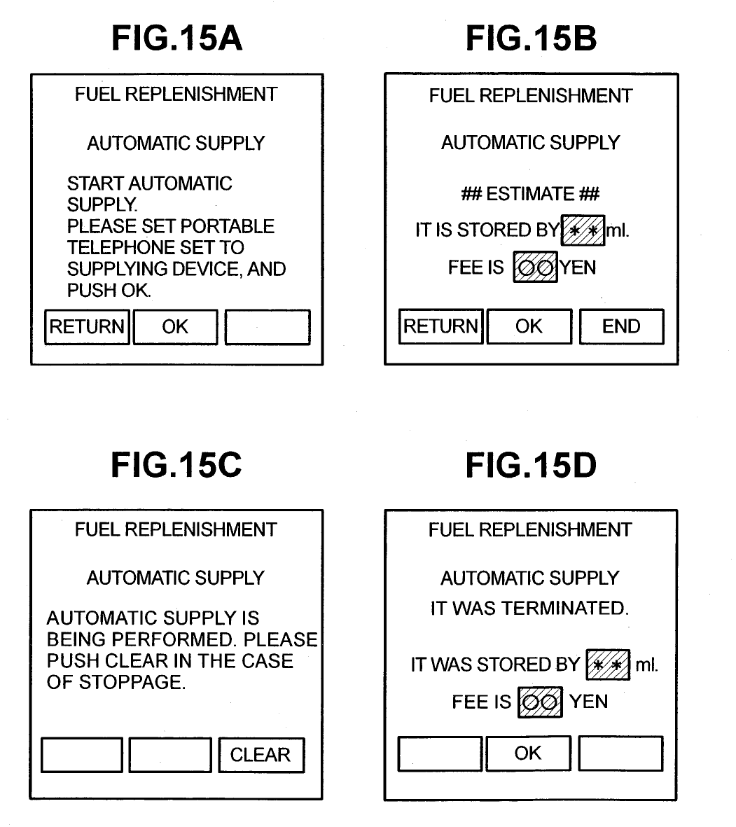

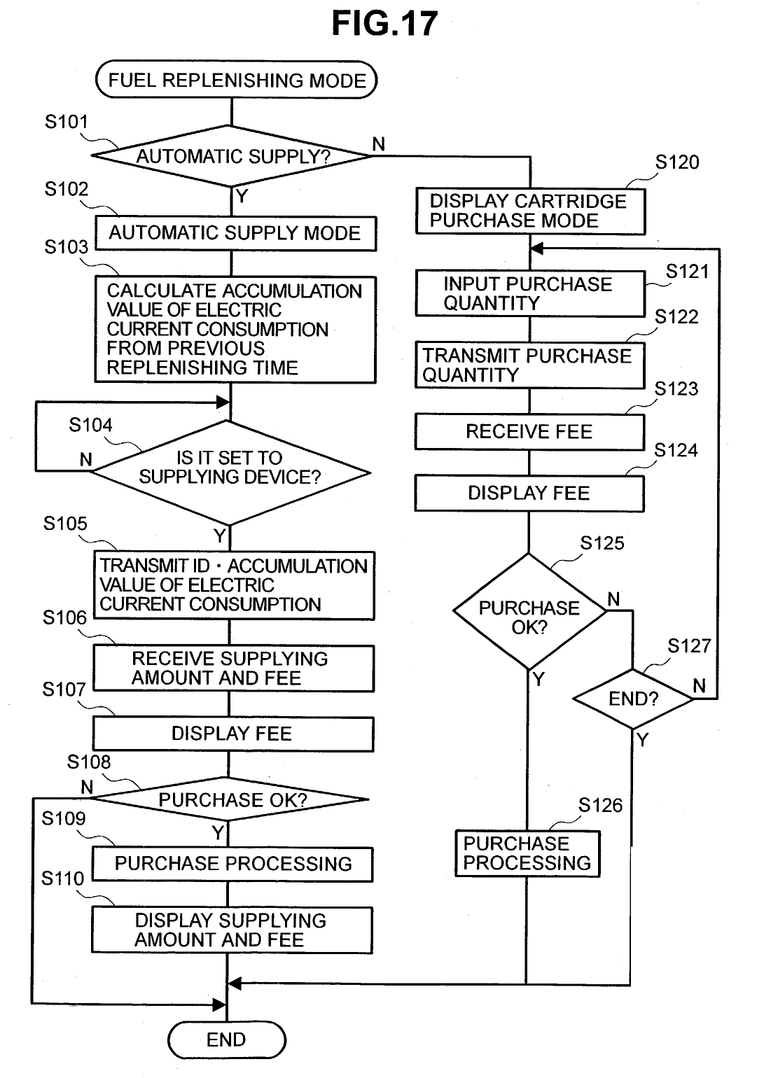

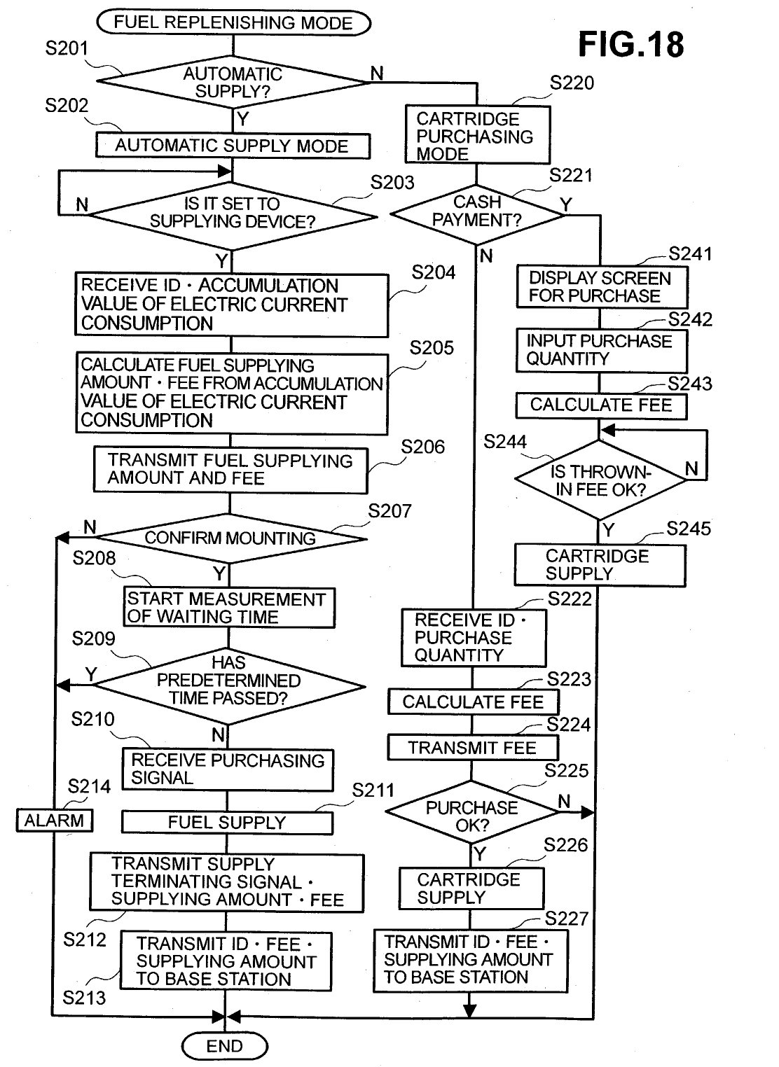

Processing in portable telephone 400 and fuel supplying device 600 are explained next using FIGS. 17 and 18. When the user of portable telephone 400 selects automatic supply on the screen of FIG. 14A (S101), the screen of display section 104 is transferred to the automatic supply start screen shown in FIG. 15A. The user then sets portable telephone 400 in portable telephone mounting portion 630 to insert tap 625 into fuel supplying port 305, and operates touch panel 642 in a portion of the “automatic supply” on display screen 640 of fuel supplying device 600 of FIG. 9 (S201). Thus, fuel supplying device 600 is set to an automatic supply mode (S202), and the transactions shown in FIG. 11 are started.

When the user wants to proceed with the processing in the following operation, the user operates the “OK” key in input section 101. When the user wants to return the processing to the previous step, the user operates the “return” key. When the user wants to cancel input contents, the user performs the key operation “clear”.

When the user operates the “OK” key as shown in FIG. 15A, the automatic supply mode is started (S102), and portable telephone 400 reads the data regarding electric current consumption from the previous refueling/charging time from memory section 103, and calculates an accumulated value for electric current consumption (S103). The electric current consumption is sampled at a predetermined time and is stored in memory section 103. The accumulated value of the electric current consumption may be also stored in the memory section 103 every sampling time from the previous replenishing time. It is next confirmed whether the portable telephone is set to fuel supplying device 600 (S104, S203). With respect to this confirmation, mounting is confirmed by transmitting a signal for the confirmation from control section 102 of portable telephone 400 to control section 610 of fuel supplying device 600 through communication section 500 and communication section 662, and making a reply from control section 610. When no reply is obtained (S104, S203), the signal transmission is repeated. If no reply is obtained even when the signal transmission is repeated a predetermined number of times, an error is displayed and the processing is terminated. This step is not illustrated.

When the setting is confirmed (S104), ID information and the accumulated value of the electric current consumption are transmitted to fuel supplying device 600 (S106). Fuel supplying device 600 confirms the mounting of the portable telephone set 400 by receiving the confirming signal from control section 102, and returns a response signal (S203). Next, the ID information and the accumulated value of electric current consumption are received (S204), and the supplied amount of the fuel and a fee are calculated from the received accumulated value of the electric current consumption (S205), and are transmitted to the portable telephone set 400 through communication section 662 and antenna 612 (S206).

Thereafter, fuel supplying device 600 again confirms the mounting to confirm whether the user seeing the fee does not detach portable telephone 400 from the portable telephone mounting portion 630 to stop the fuel supply, or tap 625 and fuel supplying section 305 are closely attached so as not to leak fuel (S207). If portable telephone 400 is detached from portable telephone mounting portion 630 (S207), an alarm is generated (S214) and processing is terminated. In contrast to this, when the mounting is confirmed (S207), the waiting time for a purchasing signal from portable telephone 400 begins to be counted. If no purchasing signal is received even when a predetermined time or more has passed (S209), it is considered an abnormality or it is believed that the user has no intention of making the purchase. An alarm is then generated (S214) and the processing is terminated.

When portable telephone 400 receives the amount of fuel supplied amount and the fee (S106), portable telephone 400 displays the fuel amount and the cost as estimated values in display section 104 as shown in FIG. 151B. In this figure, both the supplied fuel amount and the cost are displayed, but only the cost may be also displayed as an estimate. If the user purchases the fuel at this estimated value, the user operates the “OK” key (S108). In contrast to this, if the user does not purchase the fuel, the user operates the “end” key. (S108). If the user purchases the fuel, a purchasing signal is transmitted to fuel supplying device 600 as purchase processing (S109).

When fuel supplying device 600 receives the purchasing signal (S210), fuel supplying device 620 is operated and the fuel is supplied (S211). In the meantime, display section 104 of portable telephone 400 shows that automatic supply is being performed as shown in FIG. 15C. When the fuel supply is terminated, fuel supplying device 600 transmits a supply terminating signal to portable telephone 400 together with the amount of fuel supplied and the fee (S212). Portable telephone 400 again displays the fuel amount supplied and the cost in the display section 104 by receiving this signal as shown in FIG. 15D (S110). The amount of fuel supplied and the cost are the actual amount of fuel supplied and the actual cost. Similar to the estimating time, only the amount of money may be also displayed in this step. Here, when the user operates the “OK” key, processing is terminated and a waiting-receiving screen is displayed. When no user performs the key operation for a predetermined time or more in step S110, the processing is terminated and the waiting-receiving screen is displayed to prevent further power consumption by the battery.

In contrast to this, fuel supplying device 600 transmits the supply terminating signal to portable telephone 400 together with the amount of fuel supplied and the fee. Thereafter, the ID of portable telephone 400 and the fee are transmitted to base station 900 (S213) and processing is terminated. At this time, the amount of fuel supplied may be also transmitted to the base station together with the ID information and the fee. In the process of the fuel supply, the screens of FIGS. 15A, 15B, 15C and 15D may be also displayed in display section 640 of the fuel supplying device 600.

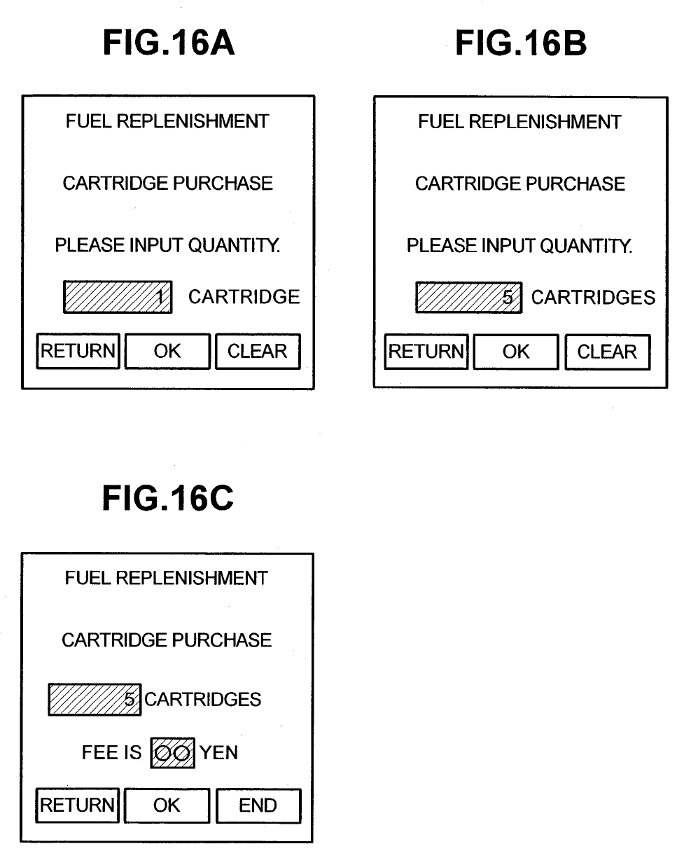

A method for purchasing cartridge 700 using portable telephone 400, and the user's paying the fee together with the telephone conversation fee or the data communication fee charged to the account of portable telephone 400 is explained next. When the user of portable telephone 400 wants to purchase a cartridge, the user selects “cartridge purchase” on the screen of FIG. 14B (S101). Then, the screen of display section 104 is transferred to a cartridge purchase start screen of FIG. 16A. The user puts portable telephone 400 in portable telephone mounting portion 630 of fuel supplying device 600, and operates touch panel 642 in a portion of “cartridge purchase (payment at the same time as the telephone conversation fee)” on display screen 640 of the fuel supplying device of FIG. 9 (S201, S220, S221). Thus, the transactions shown in FIG. 12 are started.

In the case of the cartridge purchase, the cartridge is supplied by quantity required by portable telephone 400. Accordingly, since there is no fear of fuel leakage between tap 625 and fuel supplying port 305, the process of mounting confirmation can be omitted. However, it is desirable to mount portable telephone 400 to portable telephone mounting portion 630 to stably perform communication between portable telephone set 400 and fuel supplying device 600 through communication section 500, antenna 510, antenna 612 and communication section 662.

In this state, a cartridge supplying mode is started (S120), and the quantity input screen of FIG. 16A is displayed in display section 104 of portable telephone 400. In this case, the quantity is displayed as one in default on the screen. The user operates the “OK” key if the number of purchases is one. In contrast to this, for example, when the user buys five or more cartridges, the user inputs a numerical value by using a numerical value key of input section 101, and inputs the purchase quantity by operating the “OK” key (S121). In this case, the inputted numerical value is overwritten in the default display and is displayed as shown in FIG. 16B. Portable telephone 400 transmits the purchase quantity to fuel supplying device 600 through communication section 500 together with the ID information (S122). When fuel supplying device 600 receives the purchase quantity and t ID information (S222), fuel supplying device 600 calculates the fee (S223), and transmits the fee to portable telephone 400 through communication section 662 (S224). When portable telephone 400 receives the fee (S123), portable telephone 400 displays the purchase quantity of the cartridges assigned by the user and the cost in display section 104 as shown in FIG. 16C.

When the user wants to correct the purchase quantity and operates the “return” key, the screen returns to the quantity input step (S121). The user again inputs the purchase quantity from the screen of FIG. 16A or 16B. When the user operates the “end” key on the screen of FIG. 16C, processing end is selected (S127), and portable telephone 400 terminates the processing and is returned to the waiting-receiving state.

In contrast to this, when the user operates the “OK” key in the display state of FIG. 16C (S125), portable telephone 400 transmits a purchase signal to fuel supplying device 600 as purchase processing (S 126). When fuel supplying device 600 receives the purchase signal from portable telephone 400 (S225), the control section controls the operation of cartridge supplying section 650 to supply the cartridges of the quantity transmitted from portable telephone 400 to cartridge port 652. Fuel supplying device 600 transmits the ID information of portable telephone 400 and fee information to base station 900 (S227), and the processing is terminated. At this time, the information regarding the quantity of cartridges sold may be simultaneously transmitted.

When the fee is transmitted in step S224 and no purchasing signal is received within a predetermined time, it is considered an abnormality or it is believed that the user has no intention of making the purchase (S225). This step is not illustrated in FIG. 18. An alarm is then generated and processing is terminated.

When base station 900 receives the ID information and the fee information from fuel supplying device 600, base station 900 performs account processing such that the fee for the cartridge(s) is added to the telephone conversation fee or the data communication fee of the user of the portable telephone and is collected. Thus, the user can purchase cartridge 700 without having cash.

A case in which the user of portable telephone 400 purchases cartridge 700 with cash is now explained. In this case, since no ID information is required, it is not necessary to mount portable telephone 400 to portable telephone mounting portion 630. Further, the user can purchase the cartridge even when no user is carrying portable telephone 400. In this case, the user selects “cartridge purchase (cash payment”) on the screen of FIG. 9 displayed in display section 640 of fuel supplying device 600 (S221). The quantity input screen shown in FIG. 16A and ten keys are displayed in display section 640 (S241). The quantity is displayed as “one” in default on the quantity input screen. If the quantity of one is right, the user operates “OK” on the touch panel. In contrast to this, if the user purchases five cartridges, the user inputs 5 from the ten keys displayed in the touch panel (S242). Thus, the screen is changed as shown in FIG. 16B.

When the user operates “OK” of the touch panel in FIG. 16A or 16B, the purchase quantity of the cartridge assigned by the user and a fee with respect to this purchase quantity are displayed in display section 640 as shown in FIG. 16C (S243). In FIG. 16C, the user operates “OK” of the touch panel, and adds in the fee from coin port 658. If the added-in fee is equal to or greater than the displayed amount of money (S244), the cartridge is supplied at the cartridge port 652. When the added-in amount of money exceeds the displayed fee, the change is returned at the cartridge port 652. At this time, a receipt may be also be issued. In contrast to this, when the added-in fee is insufficient (S244), the process waits for the adding-in of a sufficient fee for a predetermined time. This step is not shown in FIG. 18. When no sufficient fee is added-in, even when this time has passed, a voice guidance clarifying the insufficiency of the fee is generated from voice guidance device 668. When no sufficient fee is yet added-in, the added-in fee is returned to cartridge port 652 and the processing is terminated. In this case, no fuel supplying device 600 communicates with base station 900.

In this embodiment, after portable telephone 400 is mounted to fuel supplying device 600, both the operations of portable telephone 400 and fuel supplying device 600 are required. However, when portable telephone 400 is mounted to fuel supplying device 600, the screen of FIG. 9 is displayed. Here, when “automatic supply” is selected, the process S102 to S107 of FIG. 17 and the process S202 to S210 of FIG. 18 may be automatically performed by controlling the operation of portable telephone 400 by control section 610 of fuel supplying device 600. Thus, after the user mounts portable telephone 400 to fuel supplying device 600 and selects “automatic supply,” it is sufficient for the user to input only yes or no for the purchase with respect to the displayed fee. In the case of “yes”, the processings of fuel replenishment and the accounting are automatically performed. Thus, user operation can be simplified.

In the explanation of the embodiments, the portable electronic device is a portable telephone as an example. However, the present invention is not limited to this case, but may be also applied to a portable information terminal device (PDA) having a communication function using a voice or data (including the Internet and electronic mail) between this terminal device and the base station or center, and can be used in a system for performing accounting with respect to communication, a method for supplying fuel to a portable type personal computer, etc., and a charging method.

In accordance with the present invention, it is possible to provide a portable electronic device, a power supplying device and a power supplying method capable of easily performing refueling or the battery charging.

What is claimed is:

1. A portable electronic device having a battery as a power source, comprising:
a display which displays that a remaining energy of the battery is small;
a position receiver which receives position information;
a transmitter which transmits position information received by the position receiver and information showing a portable electronic device model to a base station; and
a device information receiver which receives supplying device information showing a position of a supplying device able to supply fuel or give a charge of electricity to the battery from the base station.

2. A portable electronic device according to claim 1, wherein
the portable electronic device has a notification receiver which receives notification showing that the remaining amount of the battery is small from the base station, and
the display performs display in accordance with the notification received by the notification receiver.

3. A portable electronic device according to claim 2, wherein the notification received by the notification receiver has information showing a required fuel supplying amount or charging amount.

4. A portable electronic device according to claim 1, wherein
the portable electronic device transmits identification information for discriminating the portable electronic device and information showing a fuel supplying amount or a charging amount to a supplying device able to supply the fuel or give the charge of electricity to the battery.

5. A supplying device able to supply fuel or give a charge of electricity to a battery of a portable electronic device, comprising:
a mounting section which mounts the portable electronic device;
a receiving section which receives ID information for discriminating the portable electronic device from the portable electronic device;
a supplying section which supplies the fuel or giving the charge of electricity to the battery of the portable electronic device; and
a transmitting section which transmits information corresponding to compensation for the fuel supply or the charging performed by the supplying section to a base station.

6. A supplying device according to claim 5, wherein
the receiving section receives supplying information showing the supplying amount of the fuel or the charging amount from the portable electronic device; and
the supplying section supplies the fuel or gives the charge of electricity to the battery of the portable electronic device in accordance with the supplying information.

7. A supplying device according to claim 5, wherein
the supplying device has a selecting section which selects a paying method of the compensation, and the transmitting section transmits no information corresponding to the compensation to the base station when the paying method using cash is selected by the selecting section.

8. A replenishing method for replenishing fuel to a portable electronic device, comprising the steps of:
transmitting position information relating to the position of the portable electronic device and device information showing a portable electronic device model from the portable electronic device to a base station;
transmitting information showing the position of a supplying device able to replenish the fuel from the base station to the portable electronic device in accordance with the position information and the device information when the base section receives the position information relating to the position of the portable electronic device;
transmitting identification information able to discriminate the portable electronic device from the portable electronic device to the supplying device; and
transmitting the identification information and information relating to compensation of the fuel supply from the supplying device to the base station after the supplying device supplies the fuel to the portable electronic device.

9. A portable electronic device having a battery as a power source, comprising:
a notifying section which performs predetermined notification when a remaining amount of the battery is smaller than a predetermined amount;
a position receiving section which receives position information;
a transmitting section which transmits the position information received by the position receiving section, and information showing a portable electronic device model to a base station; and
a device information receiving section for receiving supplying device information showing the position of a supplying device able to supply fuel or give a charge of electricity to the battery from the base station.
